(19) United States
(12) Patent Application Publication
(10) Pub. No.: US 2007/0101277 A1
(43) Pub. Date: May 3, 2007

(54) Navigation apparatus for three-dimensional graphic user interface

(75) Inventors: Min-chul Kim, Seoul (KR); Young-wan Seo, Suwon-si (KR); Joo-kyung Woo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/586,513

(22) Filed: Oct. 26, 2006

(30) Foreign Application Priority Data
Oct. 26, 2005 (KR) 10-2005-0101511

(51) Int. Cl. G06F 3/00

(52) U.S. Cl. 715/757

(57) ABSTRACT

A navigation apparatus for a three-dimensional graphic user interface is provided. The navigation apparatus includes an input unit including a first directional key that is used for directional movement in a predetermined plane and has a predetermined thickness and a second directional key that is used for directional movement along an axis orthogonal to the plane and has a thickness different from that of the first directional key; and an object control unit controlling directional movement corresponding to one of the first and second directional keys selected by a user.

### CROSS-REFERENCE TO RELATED APPLICATIONS

This application claims priority from Korean Patent Application No. 10-2005-0101511 filed on Oct. 26, 2005 in the Korean Intellectual Property Office, the disclosure of which is incorporated herein by reference in its entirety.

### BACKGROUND OF THE INVENTION

1. Field of the Invention

Apparatuses consistent with the present invention relate to navigation in a graphical user interface, and more particularly, to navigation for movement in a z-axis in a three-dimensional graphic user interface.

2. Description of the Related Art

In general, graphic user interfaces (hereinafter, referred to as GUIs) are used in digital apparatuses to conveniently use the digital apparatuses and to rapidly and intuitively provide information to a user. The user can move a pointer using an input device, such as a key pad, a keyboard, or a mouse, and select an object indicated by the pointer, thereby instructing the digital apparatus to perform a desired operation.

The GUIs are mainly classified into two-dimensional GUIs and three-dimensional GUIs. The two-dimensional GUI is two-dimensional and static, and the three-dimensional GUI is three-dimensional and dynamic. Therefore, as compared with the two-dimensional GUI, the three-dimensional GUI can communicate information to the user more visually, and further satisfy the sensitivity of the user. For this reason, two-dimensional GUIs used in digital apparatuses have been replaced with three-dimensional GUIs.

Although the two-dimensional GUIs of digital apparatuses have been replaced with the three-dimensional GUIs, a related digital apparatus can merely navigate the two-dimensional GUI by using, for example, four directional keys or a joystick.

A problem in the related art causes a user to be confused by navigating the three-dimensional GUI using a two-dimensional input device, and is a restriction in developing various three-dimensional GUIs. In order to solve the above-mentioned problem, various techniques have been proposed (for example, Korean Patent Unexamined Publication No. 2004-0090133, titled “METHOD OF ALLOCATING KEY BUTTONS OF PORTABLE TERMINAL FOR CONTROLLING THREE-DIMENSIONAL IMAGE”). However, the above-mentioned disclosures are not enough to completely solve the problem.

Therefore, an input device capable of navigating a three-dimensional GUI is needed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention is made to address the above-mentioned problems, and it is an aspect of the invention to provide a navigation apparatus for a three-dimensional graphic user interface.

However, the invention is not limited to the above-mentioned aspect, and other aspects of the invention not described herein will become clear to those skilled in the art upon review of the exemplary embodiments.

According to an aspect of the present invention, there is provided a navigation apparatus for a three-dimensional graphic user interface including an input unit that includes a first directional key that is used for directional movement in a plane and has a first thickness and a second directional key that is used for directional movement along an axis orthogonal to the plane and has a second thickness different from the first thickness; and an object control unit that controls directional movement corresponding to one of the first and second directional keys selected by a user.

### BRIEF DESCRIPTION OF THE DRAWINGS

The above and other aspects of the present invention will become more apparent by describing in detail exemplary embodiments thereof with reference to the attached drawings, in which:

FIG. 1 is a diagram illustrating the overall structure of a three-dimensional graphic user interface according to an exemplary embodiment of the present invention;

FIG. 2 is a block diagram illustrating a navigation apparatus for a three-dimensional graphic user interface according to an exemplary embodiment of the present invention;

FIG. 3 is a diagram illustrating the arrangement of first and second key input units according to an exemplary embodiment of the present invention and a cross-sectional view taken along the line III-III′;

FIG. 4 is a diagram illustrating the arrangement of first and second key input units according to another exemplary embodiment of the present invention and a cross-sectional view taken along the line IV-IV′;

FIG. 5 is a diagram illustrating the arrangement of first and second key input units according to still another exemplary embodiment of the present invention and a cross-sectional view taken along the line V-V′;

FIG. 6 is a diagram illustrating the arrangement of first and second key input units according to yet another exemplary embodiment of the present invention and a cross-sectional view taken along the line VI-VI′;

FIGS. 7A to 7D are diagrams illustrating an example of a screen provided by the navigation apparatus for a three-dimensional graphic user interface according to the exemplary embodiment of the present invention; and

FIG. 8 is a flowchart illustrating a navigation process performed in the navigation apparatus for a three-dimensional graphic user interface according to the exemplary embodiment of the present invention.

### DETAILED DESCRIPTION OF THE EXEMPLARY EMBODIMENTS OF THE INVENTION

Advantages and features of the present invention and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinafter, a navigation apparatus for a three-dimensional graphic user interface according to exemplary embodiments of the present invention will be described below with reference to block diagrams and flowcharts of the accompanying drawings. It will be understood that blocks in the accompanying block diagrams and combinations of steps in flow charts can be performed by computer program instructions. These computer program instructions can be provided to processors of, for example, general-purpose computers, special-purpose computers, and programmable data processing apparatuses. Therefore, the instructions performed by the computer or a processor of the programmable data processing apparatus create means for executing functions described in the blocks in block diagrams or the steps in the flow charts. The computer program instructions can be stored in a computer usable memory or a computer readable memory of the computer or the programmable data processing apparatus in order to realize the functions in a specific manner. Therefore, the instructions stored in the computer usable memory or the computer readable memory can manufacture products including the instruction means for performing the functions described in the blocks in the block diagrams or the steps in the flow charts. Also, the computer program instructions can be loaded into the computer or the computer programmable data processing apparatus. Therefore, a series of operational steps are performed in the computer or the programmable data processing apparatus to generate a process executed by the computer, which makes is possible for the instructions operating the computer or the programmable data processing apparatus to provide steps of executing the functions described in the blocks of the block diagrams or the steps of the flow charts.

Each block or each step may indicate a portion of a code, a module, or a segment including one or more executable instructions for performing a specific logical function (or functions). It should be noted that, in some modifications of the invention, the functions described in the blocks or the steps may be generated in a different order. For example, two blocks or steps continuously shown may actually be performed at the same time, or they may sometimes be performed in reverse order according to the corresponding functions.

Before a navigation apparatus for a three-dimensional graphic user interface (hereinafter, referred to as a navigation apparatus) according to an exemplary embodiment of the invention is described, a three-dimensional graphic user interface provided in the navigation apparatus will be briefly described below.

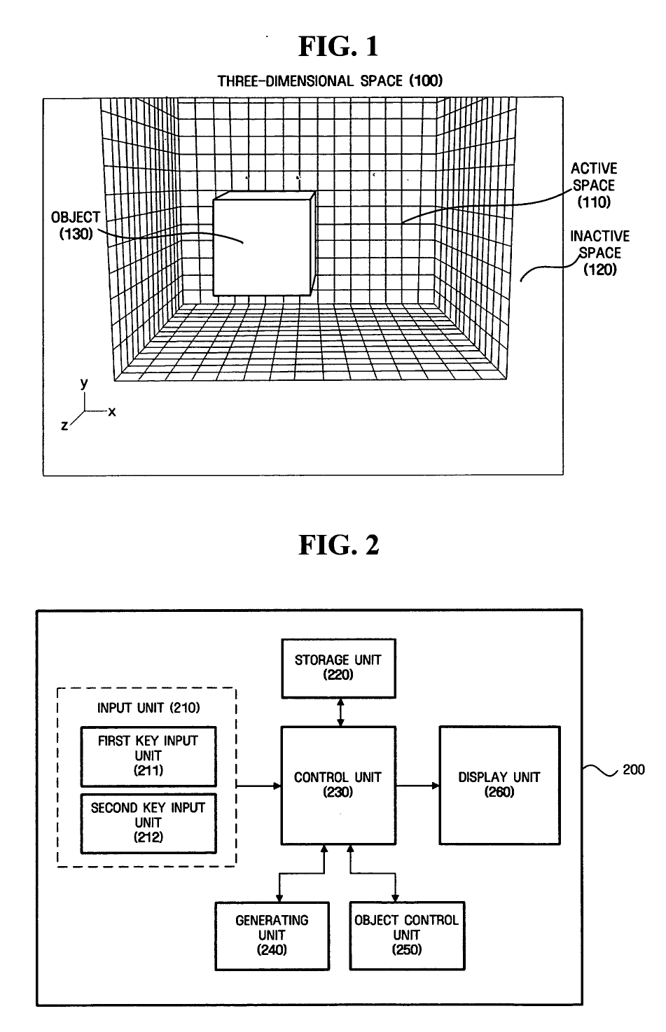

FIG. 1 illustrates the overall configuration of a three-dimensional graphic user interface provided in a navigation apparatus according to an exemplary embodiment of the present invention.

The three-dimensional graphic user interface is a user interface (UI) capable of establishing a more dynamic GUI environment on the basis of a three-dimensional environment and motion graphics. The three-dimensional graphic user interface environment includes the following elements: a three-dimensional space 100; objects 130; a camera view; and a method of arranging objects.

A three-dimensional space 100 is a space for establishing the three-dimensional environment, and it may be divided into an active space 110 and an inactive space 120 according to the characteristic of the space. The active space 110 can be used to design a user interface (UI).

An object 130 provides information to a user while interacting with the user in the three-dimensional environment. The object 130 includes one or more information surfaces. The information surface means a surface capable of displaying information to be communicated to a user, and information on controllable menu items or information on sub-menu items can be communicated to the user by means of the information surfaces. Two-dimensional information items, such as texts, images, moving pictures, and two-dimensional widgets, can be displayed on the information surfaces. In addition, three-dimensional information, such as three-dimensional icons, can be displayed on the information surfaces.

The object 130 can have a polyhedral shape, such as a triangular prism, a square pillar, a hexagonal prism, or a cylinder. A sphere may be assumed to be an example of a polyhedron formed of numerous surfaces. The polyhedral object has attributes, such as an identifier and a size. The polyhedron object has, as surface attributes, a number, a color, transparency, and information on whether a corresponding surface is an information surface. These attributes are not limited to those mentioned above, and a variety of attributes may exist according to application fields.

The object 130 can generate a unique motion in the three-dimensional space. For example, the object 130 can rotate on a specified axis at a particular angle and in a specified direction. In addition, the position of the object 130 may be shifted, or the size thereof may increase or decrease.

The camera view means a view point in the three-dimensional space. The camera view can move in the three-dimensional space. The movement of the camera view means navigation in the three-dimensional space, which causes motion to be generated in the entire three-dimensional space. The camera view is the main cause of motion in the three-dimensional graphic user interface environment, along with unique motion attributes of the objects.

A method of arranging the objects means a method of determining how to manipulate a group of one or more objects in the three-dimensional space, what operation occurs during the manipulation, and how to arrange the objects on a screen.

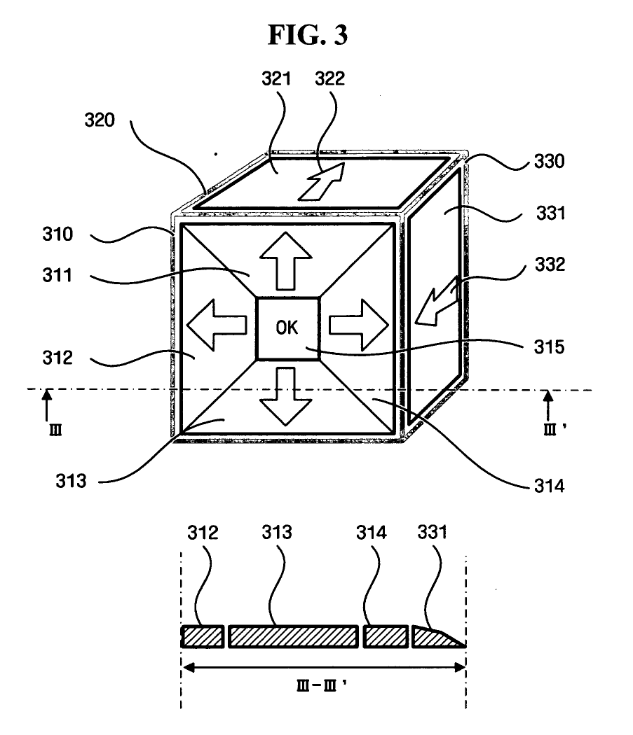

FIG. 2 is a block diagram illustrating a navigation apparatus 200 according to an exemplary embodiment of the present invention.

The navigation apparatus 200 according to the exemplary embodiment of the present invention may be composed of a digital apparatus including digital circuits for processing digital data. Examples of the digital device may include a computer, a printer, a scanner, a pager, a digital camera, a facsimile, a digital copying machine, a digital appliance, a digital telephone, a digital projector, a home server, a digital video recorder, a digital TV broadcasting receiver, a digital satellite broadcasting receiver, a set-top box, a personal digital assistance (PDA), and a mobile phone.

The navigation apparatus 200 shown in FIG. 2 includes a generating unit 240, a storage unit 220, a display unit 260, an object control unit 250, a control unit 230, and an input unit 210.

The generating unit 240 generates a three-dimensional space composed of an x-axis, a y-axis, and a z-axis and polyhedral objects to be arranged in the three-dimensional space.

The storage unit 220 stores information on the three-dimensional space and the polyhedral objects generated by the generating unit 240, and the attributes of the polyhedral objects. For example, the storage unit 220 stores information on the colors and transparency of the surfaces of the polyhedral objects and information on whether the surfaces of the polyhedral objects are information surfaces. The storage unit 220 may be composed of at least one of a non-volatile memory device, such as a read only memory (ROM), a programmable ROM (PROM), an erasable programmable ROM (EPROM), an electrically erasable programmable ROM (EEPROM), or a flash memory, a volatile memory device, such as a random access memory (RAM), and a storage medium, such as a hard disk drive (HDD), but the storage unit 220 is not limited to the above-mentioned devices.

The display unit 260 visually displays the polyhedral object generated by the generating unit 240 and the result processed by the object control unit 250, which will be described below. The display unit 260 can be composed of an image display device, such as a liquid crystal display device (LCD), a light-emitting diode (LED), an organic light-emitting diode (OLED), or a plasma display panel (PDP), but it is not limited to the above-mentioned devices.

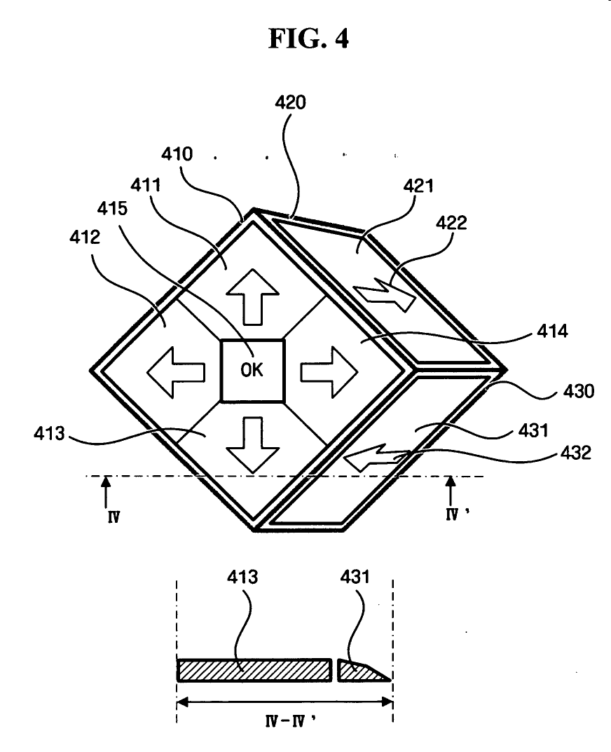

The input unit 210 receives input values from a user, and includes a first key input unit 211 for directional movement in an x-y plane and a second key input unit 212 for movement in the z-axis direction. When the keys of the input unit 210 are pushed by the user, the keys generate key signals. The input unit 210 will be described in more detail below with reference to FIGS. 3 to 6.

The control unit 230 connects and controls all the components of the navigation apparatus 200. For example, the control unit 230 generates instruction codes corresponding to the input values input through the input unit 210 and transmits the generated instruction codes to the object control unit 250.

The object control unit 250 uses the object generated by the generating unit 240 to provide a three-dimensional graphic user interface. More specifically, the object control unit 250 gives the above-mentioned attribute to the object generated by the generating unit 240, and processes the motion of an object on the basis of the input values input by the user. For example, the object control unit 250 shifts the position of the object, changes the size of the object, or rotates the object. In addition, the object control unit 250 emphasizes the object selected by the user. For example, the object control unit 250 forms a mark in the vicinity of the object selected by the user or changes the size, color and transparency of the selected object to emphasize the object. Alternatively, the object control unit 250 may emphasize the object selected by the user by changing the sizes, colors, and transparency of objects not selected by the user.

Next, the input unit 210 of the navigation apparatus 200 according to the exemplary embodiment of the invention will be described with reference to FIGS. 3 to 6.

As described above, the input unit 210 includes the first key input unit 211 for directional movement in the x-y plane and the second key input unit 212 for movement in the z-axis direction.

More specifically, the first input key 211 includes a right key, a left key, an up key, and a down key. The right and left keys are used for movement in the positive and negative directions of the x-axis, respectively. The up and down keys are used for movement in the positive and negative directions of the y-axis, respectively. The second key input unit 212 includes keys for movement in the positive and negative directions of the z-axis.

The regions 310, 320 and 330 in which the first key input unit 211 and the second key input unit 212 are arranged may be formed in such a shape that the user can intuitionally recognize the functions of the directional keys. FIGS. 3 show an example of the arrangement of the regions.

FIG. 3 shows a two-dimensionally projected hexahedron having the regions 310, 320, and 330 projected on the surfaces thereof. The hexahedron shown in FIG. 3 includes the first rectangular region 310, the second region 320 formed above the first region 310, and the third region formed on one side of the first region 310. Among the regions 310, 320, and 330, the up key 311, the down key 313, the left key 312, and the right key 314 are arranged in the first region 310, and the keys corresponding to the negative and positive directions of the z-axis are arranged in the second region 320 and the third region 330, respectively.

In this case, the keys 311, 312, 313, and 314 arranged in the first region 310 may have the same height such that the user can intuitionally recognize that the keys are used for directional movement in the x-y plane when the user touches the first region 310.

On the other hand, the height of the keys arranged in the second region 320 and the third region 330 may become smaller, as the keys become more distant from the keys arranged in the first region 310, that is, the first input keys, such that the user can intuitionally recognize that the keys arranged in the second and third regions 320 and 330 are used for movement in the z-axis direction, when touching the second region 320 and the third region 330. That is, the keys arranged in the second region 320 and the third region 330 may be formed as in the cross section shown in FIG. 3

In an exemplary embodiment, marks 322 and 332 are formed in the keys 321 and 331 respectively arranged in the second region 320 and the third region 330 such that the user can recognize the functions of the keys. For example, a key for movement in the positive direction of the z-axis or a key for movement in the negative direction of the z-axis may be arranged in the second region 320. When the key 321 for movement in the negative direction of the z-axis is arranged in the second region 320, an arrow 322 representing the negative direction of the z-axis is marked on the key of the second region 320, and an arrow 332 representing the positive direction of the z-axis is marked on the key of the third region 330, as shown in FIG. 3. In this way, the user can intuitionally recognize the directions corresponding to the keys according to the shapes of the regions 310, 320, and 330 and the marks formed on the keys.

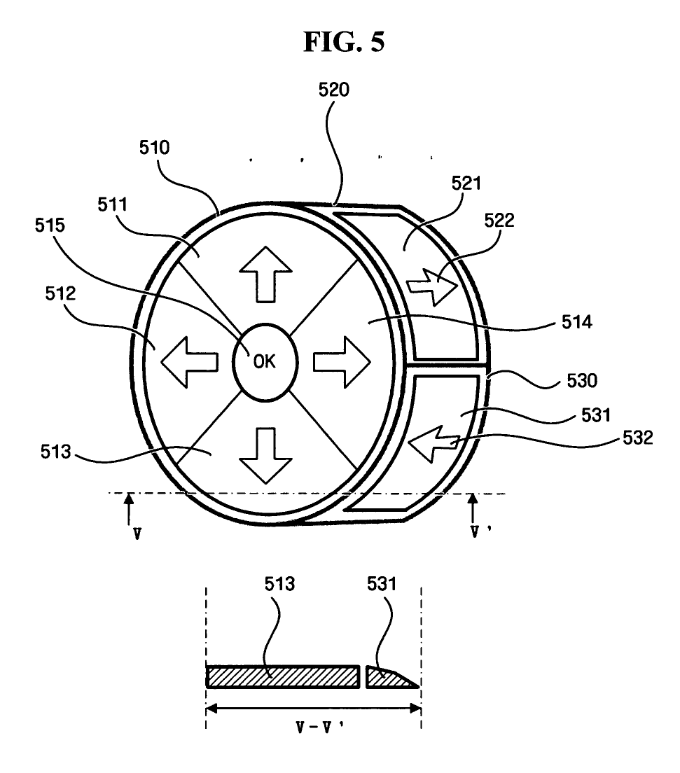

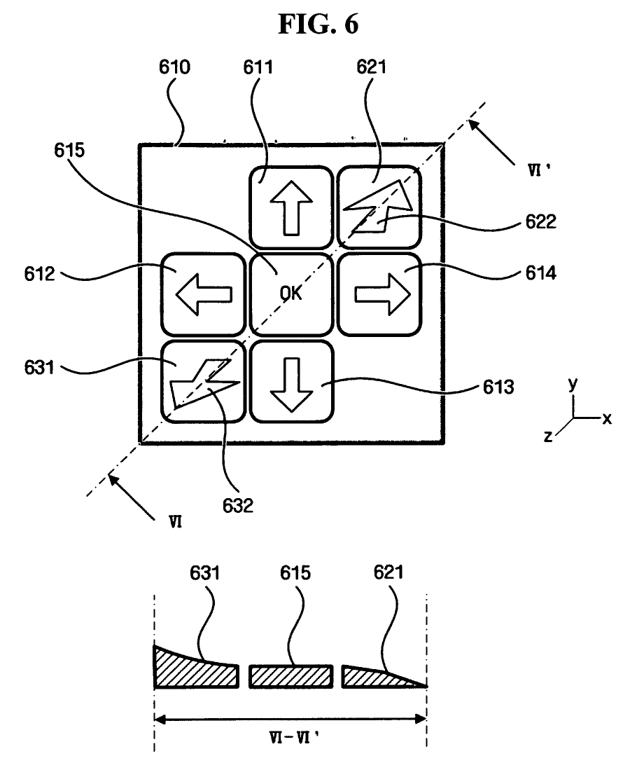

The regions in which the first key input unit 211 and the second key input unit 212 are arranged may have various shapes. FIG. 4 and FIG. 5 show modifications of the shapes of the regions.

FIG. 4 shows a hexahedron having a first lozenge-shaped region 410, a second region 420 formed adjacent to the first region 410, and a third region 430 formed adjacent to the first region 410. Among the regions 410, 420, and 430, an up key 411, a down key 413, a left key 412, and a right key 414 are arranged in the first region 410 so as to correspond to the control directions of the keys, and a key 421 corresponding to the negative direction of the z-axis and a key 431 corresponding to the positive direction of the z-axis are arranged in the second region 420 and the third region 430, respectively.

In this case, the keys 411, 412, 413, and 414 may be arranged in the first region 410 have the same height such that the user can intuitionally recognize that the keys are used for directional movement in the x-y plane when the user touches the first region 410.

On the other hand, the heights of the keys 421 and 431 arranged in the second region 420 and the third region 430 may become smaller, as the keys become more distant from the keys arranged in the first region 410, that is, the keys 411, 412, 413 and 414 of the first key input unit 211, such that the user can intuitionally recognize that the keys 421 and 431 arranged in the second and third regions 420 and 430 are used for movement in the z-axis direction, when touching the second region 420 and the third region 430. That is, the keys arranged in the second region 420 and the third region 430 may be formed as in the cross section shown in FIG. 4.

According to an exemplary embodiment, marks are formed in the keys 421 and 431 respectively arranged in the second region 420 and the third region 430 such that the user can recognize the functions of the keys. For example, an arrow 422 representing the negative direction of the z-axis is marked in the second region 420, and an arrow 432 representing the positive direction of the z-axis is marked in the third region 430. In this way, the user can intuitionally recognize the directions corresponding to the keys according to the shapes of the regions 410, 420, and 430 and the marks formed on the keys.

FIG. 5 shows a cylinder having a first circular region 510, a second region 520 formed adjacent to the first region 510, and a third region 530 formed adjacent to the first region 510. Among the regions 510, 520, and 530, an up key 511, a down key 513, a left key 512, and a right key 514 are arranged in the first region 510 so as to correspond to the control directions of the keys, and keys 521 and 531 corresponding to the negative and positive directions of the z-axis are arranged in the second region 520 and the third region 530, respectively.

In this case, similar to the above-described exemplary embodiments, the keys 511, 512, 513, and 514 arranged in the first region 510 may have the same height such that the user can intuitionally recognize that the keys are used for directional movement in the x-y plane when the user touches the keys 511, 512, 513, and 514 of the first region 510.

On the other hand, the heights of the keys 521 and 531 arranged in the second region 520 and the third region 530 become smaller, as the keys become more distant from the keys arranged in the first region 510, that is, the keys 511, 512, 513 and 514 of the first key input unit 211, such that the user can intuitionally recognize that the keys 521 and 531 respectively arranged in the second and third regions 520 and 530 are used for movement in the z-axis direction, when touching the keys 521 and 531 of the second region 520 and the third region 530.

According to an exemplary embodiment, marks are formed in the keys 521 and 531 respectively arranged in the second region 520 and the third region 530 such that the user can recognize the functions of the keys. For example, an arrow 522 representing the negative direction of the z-axis is marked in the second region 520, and an arrow 532 representing the positive direction of the z-axis is marked in the third region 530. In this way, the user can intuitionally recognize the directions corresponding to the keys according to the shapes of the regions 510, 520, and 530 and the marks formed on the keys.

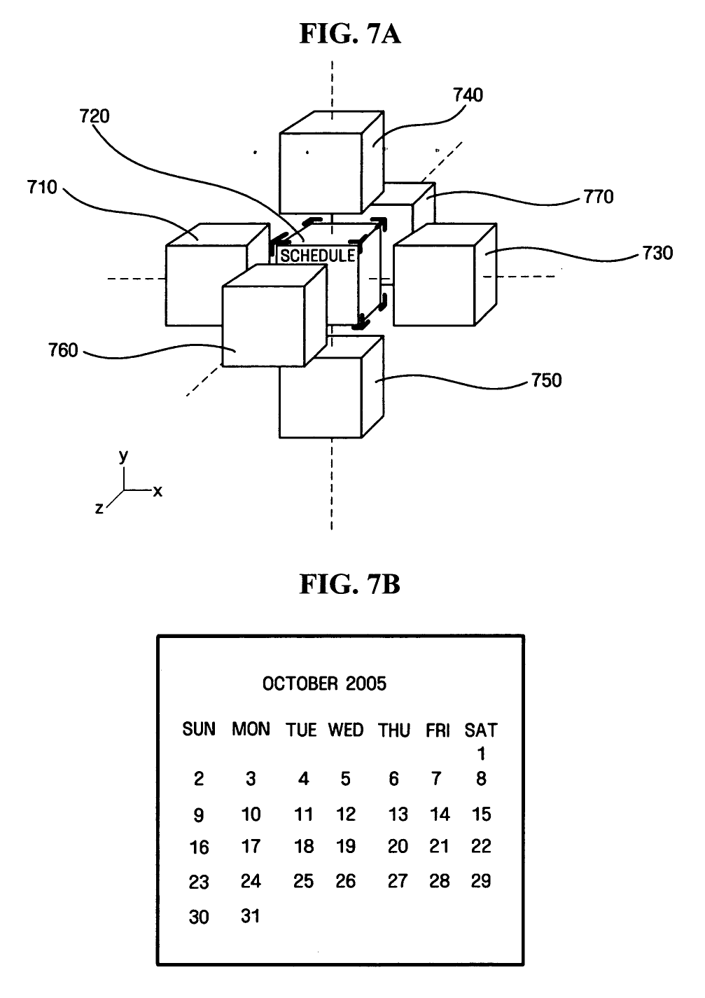

FIG. 6 is a diagram illustrating an example of the arrangement of a first key input unit 211 and a second key input unit 212 according to another exemplary embodiment of the invention and a cross-sectional view taken along the line VI-VI′.

As shown in FIG. 6, an up key 611, a down key 613, a left key 612, and a right key of the first key input unit 211 may be disposed in a cross shape in a region 610 with a run key 615 at the center thereof. The run key 615 may be optionally provided. A key 621 corresponding to the negative direction of the z-axis may be arranged between the up key 611 and the right key 614 on a diagonal line passing through the center of the run key 615, and a key 631 corresponding to the positive direction of the z-axis may be arranged between the left key 612 and the down key 613 on the diagonal line passing through the center of the run key 615.

In this case, since the up key 611, the down key 613, the left key 612, and the right key 614 are used for directional movement in the x-y plane, the keys may be formed to have the same height. In contrast, as shown in the cross section in FIG. 6, the height of the key 621 corresponding to the negative direction of the z-axis may become smaller, as it becomes more distant from the run key 615, such that the user can intuitionally recognize that the key 621 is used for movement in the negative direction of the z-axis, when touching the key 621. In addition, as shown in FIG. 6B, the height of the key 631 corresponding to the positive direction of the z-axis may become larger, as it becomes more distant from the run key 615, such that the user can intuitionally recognize that the key 631 is used for movement in the positive direction of the z-axis, when touching the key 631.

The input unit 210 may further include a power key (not shown) for supplying power to the navigation apparatus 200 and number keys (not shown) for inputting numbers, in addition to the first key input unit 211 and the second key input unit 212. When the user pushes the keys of the input unit 210, the keys generate key signals. The generated key signals are transmitted to the control unit 230. The input unit 210 may be integrated into the navigation apparatus 200 in a hardware manner, or it may be formed of a module separated from the navigation apparatus 200. When the input unit 210 is formed of a module separated from the navigation apparatus 200, the input unit 210 can transmit the input value input by the user to the navigation apparatus 200 by means of wire or wireless communication.

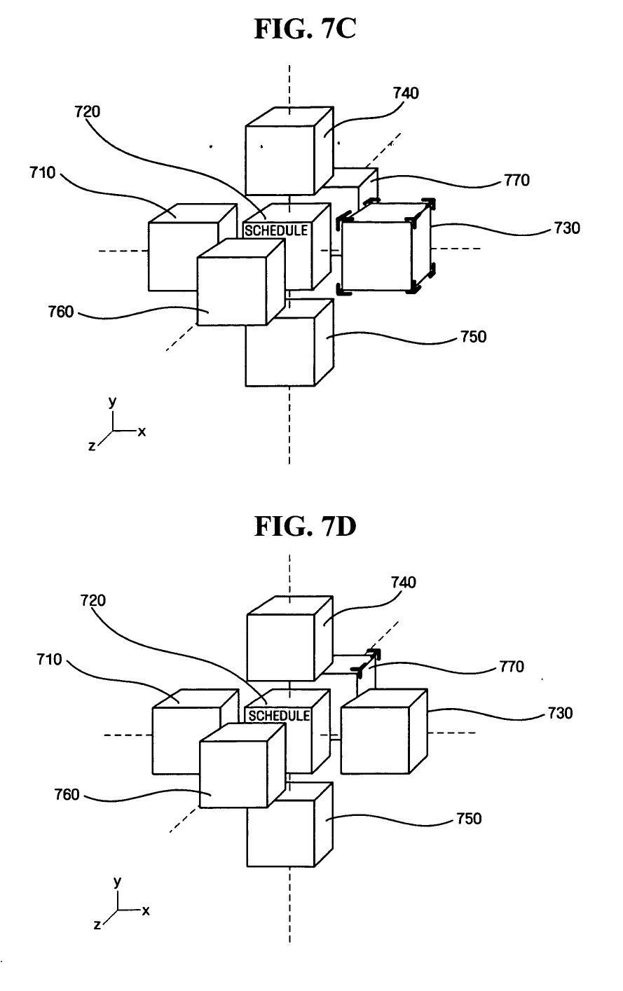

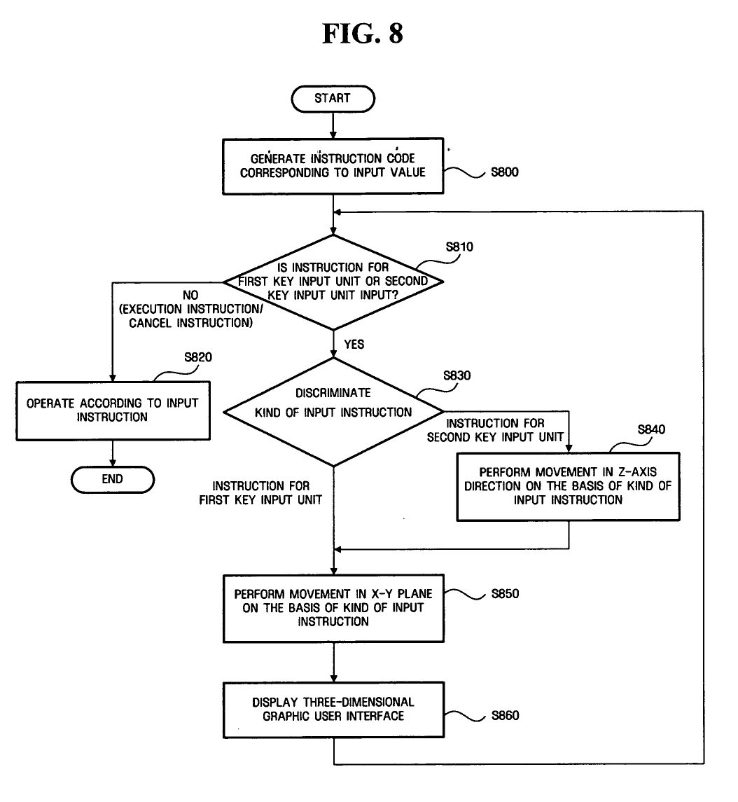

Next, a navigation process of the navigation apparatus according to an exemplary embodiment of the invention will be described below with reference to FIGS. 7A to 8. FIGS. 7A to 7D are diagrams illustrating an example of a three-dimensional graphic user interface of the navigation apparatus 200 according to the exemplary embodiment of the invention. FIG. 8 is a flowchart illustrating a navigation process performed by the navigation apparatus according to an exemplary embodiment of the invention.

The three-dimensional graphic user interface shown in FIGS. 7A to 7D includes first to third polyhedral objects 710, 720, and 730 arranged on the x-axis, fourth and fifth polyhedral objects 740 and 750 that are arranged on the y-axis with the second polyhedral object 720 at the center thereof, and sixth and seventh polyhedral objects 760 and 770 that are arranged on the z-axis with the second polyhedral object 720 at the center thereof.

When an input value is input through the input unit 210, with the three-dimensional graphic user interface displayed by the display unit 210, the control unit 230 generates an instruction code corresponding to the input value and transmits the generated instruction code to the object control unit 250. For example, when the right key of the input unit 210 is pushed, the control unit 230 generates an instruction code corresponding to a key signal of the right key and transmits the generated instruction code to the object control unit 250 (S800).

The object control unit 250 determines whether the instruction code transmitted from the control unit 230 is an instruction code for the first key input unit 211 and the second key input unit 212 (S810).

When it is determined that the transmitted instruction code is not the instruction code for the first key input unit 211 and the second key input unit 212 (S810; No), for example, when the transmitted instruction code is an instruction code for the run key (not shown) or a cancel key (not shown), the object control unit 250 executes or cancels the instruction associated with the polyhedral object currently selected. More specifically, as shown in FIG. 7A, when the run key 315, 415, 515, or 615 is pushed with the second polyhedral object 720 corresponding to “Schedule” being selected, the object control unit 250 displays a calendar as detailed information related to “Schedule”, as shown in FIG. 7B.

On the other hand, when it is determined that the transmitted instruction code is the instruction code for the first key input unit 211 and the second key input unit 212 (S810; Yes), the object control unit 250 performs directional movement in the three-dimensional graphic user interface, according to the kind of instruction code transmitted from the control unit 230 (S830).

For example, when the instruction code transmitted from the control unit 230 is the instruction code for the first key input unit 211, the object control unit 250 performs directional movement in the x-y plane according to the kind of input instruction code (S850). More specifically, when the right key 314, 414, 514, or 614 is pushed with the second polyhedral object 720 being selected as shown in FIG. 7A, the object control unit 250 forms an outline in the periphery of the third polyhedral object 730 to emphasize the third polyhedral object 730, as shown in FIG. 7C.

For example, when the instruction code transmitted from the control unit 230 is the instruction code for the second key input unit 212, the object control unit 250 performs directional movement in the z-axis according to the kind of input instruction code (S840). More specifically, when the key 322, 422, 522, or 622 corresponding to the negative direction of the z-axis is pushed with the second polyhedral object 720 being selected as shown in FIG. 7A, the object control unit 250 forms an outline in the periphery of the seventh polyhedral object 770 to emphasize the seventh polyhedral object 770, as shown in FIG. 7D. In this case, the object control unit 250 may move a view point toward the seventh polyhedral object 770 such that the seventh polyhedral object 770 appears to zoom in along the z-axis direction.

Steps S810 to S850 are performed by the object control unit 250, and the result processed by the object control unit 250 is displayed by the display unit 260 (S860).

While the navigation apparatus 200 and method for the three-dimensional graphic user interface according to the exemplary embodiments of the present invention have been described above with reference to the accompanying drawings, it will be understood by those skilled in the art that various modifications and changes of the invention can be made without departing from the scope and spirit of the invention. Therefore, it should be understood that the above-described exemplary embodiments are not restrictive, but illustrative in all aspects.

As described above, the navigation apparatus for a three-dimensional graphic user interface according to the present invention can obtain the following effects.

First, it is possible to easily perform directional movement in the x-y plane and in the z-axis direction by providing input units for the x-axis, y-axis, and z-axis directions.

Second, a user can intuitionally recognize the functions of keys according to the shapes of regions in which keys for directional movement in the x-y plane and keys for directional movement in the z-axis are arranged.

Third, a user can recognize the functions of keys by means of the sense of touch with the keys by making the height of the key for directional movement in the z-axis non-uniform.

Fourth, it is possible to prevent the confusion of use occurring when the user uses a two-dimensional input unit to navigate a three-dimensional graphic user interface.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A navigation apparatus for a three-dimensional graphic user interface, the apparatus comprising:
an input unit comprising:
a first directional key which is used for directional movement in a plane and has a first thickness, and
a second directional key which is used for directional movement along an axis orthogonal to the plane and has a second thickness different from the first thickness; and
an object control unit which controls directional movement corresponding to one of the first and second directional keys selected by a user.

2. The navigation apparatus of claim 1, wherein the second thickness has a different thickness on one side of the second directional key as compared to a second side of the second directional key.

3. The navigation apparatus of claim 1, wherein the first directional key comprises at least one of up, down, left, and right pads which direct movement in upward, downward, leftward and rightward directions in the plane, respectively, and
the second directional key comprises at least one of directional pads which direct movement in positive and negative directions of the axis.

4. The navigation apparatus of claim 3, wherein the first directional key is arranged in a cross shape having each of the pads at a position corresponding to a control direction in the plane.

5. The navigation apparatus of claim 4, wherein the directional pad for movement in the negative direction of the axis is positioned between the up pad and the right pad.

6. The navigation apparatus of claim 5, wherein a thickness of the directional pad for movement in the negative direction of the axis becomes smaller, as the directional pad for movement in the negative direction of the axis becomes more distant from the center of the directional pads arranged in the cross shape.

7. The navigation apparatus of claim 4, wherein the directional pad for movement in the positive direction of the axis is positioned between the left key and the down key.

8. The navigation apparatus of claim 7, wherein the thickness of the directional pad for movement in the positive direction of the axis becomes larger, as the directional pad for movement in the positive direction of the axis becomes more distant from the center of the directional pads arranged in the cross shape.

9. The navigation apparatus of claim 3, wherein the first directional key is arranged in the shape of a square having each of the pads at a position corresponding to a control direction in the plane.

10. The navigation apparatus of claim 9, wherein the directional pad for movement in the negative direction of the axis is positioned on a first side of the first directional key.

11. The navigation apparatus of claim 10, wherein a thickness of the directional pad for movement in the negative direction of the axis becomes smaller as the direction pad for movement in the negative direction becomes more distant from the first directional key.

12. The navigation apparatus of claim 11, wherein the directional pad for movement in the positive direction of the axis is positioned on a second side of the first directional key.

13. The navigation apparatus of claim 12, wherein a thickness of the directional pad for movement in the positive direction of the axis becomes larger as the direction pad for movement in the positive direction becomes more distant from the first directional key.

14. The navigation apparatus of claim 3, wherein the first directional key is arranged in the shape of a circle having each of the pads at a position corresponding to a control direction in the plane.

15. The navigation apparatus of claim 14, wherein the directional pad for movement in the negative direction of the axis and the directional pad for movement in the positive direction of the axis are positioned on a side of the first directional key.

16. The navigation apparatus of claim 15, wherein a thickness of the directional pad for movement in the negative direction of the axis becomes smaller as the direction pad for movement in the negative direction becomes more distant from the first directional key.

17. The navigation apparatus of claim 16, wherein a thickness of the directional pad for movement in the positive direction of the axis becomes larger as the direction pad for movement in the positive direction becomes more distant from the first directional key.

18. The navigation apparatus of claim 1, wherein the first directional key has a uniform thickness.

19. The navigation apparatus of claim 1, wherein the first directional key is arranged on a first surface, and the second direction key is arranged on a second surface having one edge coming into contact with an edge of the first surface.

20. The navigation apparatus of claim 19, wherein the second thickness of the second directional key becomes smaller, as the second directional key becomes more distant from the center of the first directional key.

21. The navigation apparatus of claim 1, further comprising a display unit displaying one of a plurality of displayed graphic objects selected according to the directional movement by the control.
